(19) United States
(12) Patent Application Publication
(10) Pub. No.: US 2024/0256863 A1
(43) Pub. Date: Aug. 1, 2024

(54) Method, System, and Computer Program Product for Improving Training Loss of Graph Neural Networks Using Bi-Level Optimization

(71) Applicant: Visa International Service Association, San Francisco, CA (US)

(72) Inventors: Huiyuan Chen, San Jose, CA (US); Mahashweta Das, Campbell, CA (US); Michael Yeh, Newark, CA (US); Yujie Fan, Cleveland Heights, OH (US); Yan Zheng, Los Gatos, CA (US); Junpeng Wang, Santa Clara, CA (US); Vivian Wan Yin Lai, Atlanta, GA (US); Hao Yang, San Jose, CA (US)

(21) Appl. No.: 18/426,717

(22) Filed: Jan. 30, 2024

Related U.S. Application Data
(60) Provisional application No. 63/442,196, filed on Jan. 31, 2023.

(51) Int. Cl. G06N 3/08; G06N 3/04

(52) U.S. Cl. CPC G06N 3/08; G06N 3/04

(57) ABSTRACT

Methods, systems, and computer program products are provided for optimizing training loss of a graph neural network machine learning model using bi-level optimization. An example method includes receiving a training dataset comprising graph data associated with a graph, training a graph neural network (GNN) machine learning model using a loss equation according to a bi-level optimization problem and based on the training dataset, where training the GNN machine learning model using the loss equation according to the bi-level optimization problem includes determining a solution to an inner loss problem and a solution to an outer loss problem, and providing a trained GNN machine learning model based on training the GNN machine learning model.

### CROSS REFERENCE TO RELATED APPLICATION

This application claims priority to U.S. Provisional Patent Application No. 63/442,196, filed on Jan. 31, 2023, the disclosure of which is incorporated by reference herein in its entirety.

### BACKGROUND

### 1. Technical Field

The present disclosure relates generally to systems, devices, products, apparatus, and methods for implementing graph neural network (GNN) machine learning models and, in some non-limiting embodiments or aspects, to a method, system, and computer program product for optimizing training loss of a GNN machine learning model using bi-level optimization.

### 2. Technical Considerations

Some machine learning models, such as neural networks (e.g., a convolutional neural network), may receive an input dataset including data points for training. Each data point in the training dataset may have a different effect on a neural network (e.g., a trained neural network) generated based on training the neural network after the neural network is trained. In some instances, input datasets designed for neural networks may be independent and identically distributed. Input datasets that are independent and identically distributed may be used to determine an effect (e.g., an influence) of each data point of the input dataset. Graph neural network (GNN) machine learning models may be designed to receive graph data (e.g., data that represents information provided by a graph), which may include nodes and edges.

However, graph data may not be independent and identically distributed. If graph data is not aligned well in such as a fashion, a GNN machine learning model may provide inferior performance. In addition, training a GNN machine learning model may require optimizing complex and/or non-convex neural networks with an abundance of local and/or global minima in a loss landscape of the GNN machine learning model. In some instances, despite having nearly the same performance on training data, different minima may cause a GNN machine learning model to differ widely in performance during testing.

### SUMMARY

Accordingly, provided are improved methods, systems, and computer program products for optimizing training loss of a graph neural network machine learning model using bi-level optimization.

According to non-limiting embodiments or aspects, provided is a computer-implemented method for optimizing training loss of a graph neural network machine learning model using bi-level optimization, comprising: receiving, with at least one processor, a training dataset comprising graph data associated with a graph, the graph comprising a plurality of nodes and the graph data comprising node data associated with each node of the graph; training, with at least one processor, a graph neural network (GNN) machine learning model using a loss equation according to a bi-level optimization problem and based on the training dataset, wherein training the GNN machine learning model using the loss equation according to the bi-level optimization problem comprises: determining a solution to an inner loss problem, wherein determining the solution to the inner loss problem comprises: determining a maximum value of a difference between a first loss of the GNN machine learning model based on model parameters and a second loss of the GNN machine learning model based on the model parameters and a perturbation value; determining a solution to an outer loss problem, wherein determining the solution to the outer loss problem comprises: determining model parameters that minimize the maximum value of the difference between the first loss of the GNN machine learning model based on the model parameters and the second loss of the GNN machine learning model based on the model parameters and the perturbation value; providing, with at least one processor, a trained GNN machine learning model based on training the GNN machine learning model.

According to non-limiting embodiments or aspects, provided is a system optimizing training loss of a graph neural network machine learning model using bi-level optimization, including: at least one processor configured to: receive a training dataset comprising graph data associated with a graph, the graph comprising a plurality of nodes and the graph data comprising node data associated with each node of the graph; and train a graph neural network (GNN) machine learning model using a loss equation according to a bi-level optimization problem and based on the training dataset, wherein, when training the GNN machine learning model using the loss equation according to the bi-level optimization problem, the at least one processor is configured to: determine a solution to an inner loss problem, wherein, when determining the solution to the inner loss problem, the at least one processor is configured to: determine a maximum value of a difference between a first loss of the GNN machine learning model based on model parameters and a second loss of the GNN machine learning model based on the model parameters and a perturbation value; determine a solution to an outer loss problem, wherein, when determining the solution to the outer loss problem, the at least one processor is configured to: determine model parameters that minimize the maximum value of the difference between the first loss of the GNN machine learning model based on the model parameters and the second loss of the GNN machine learning model based on the model parameters and the perturbation value.

According to non-limiting embodiments or aspects, provided is a computer program product for optimizing training loss of a graph neural network machine learning model using bi-level optimization that includes at least one non-transitory computer-readable medium including one or more instructions that, when executed by at least one processor, cause the at least one processor to: receive a training dataset comprising graph data associated with a graph, the graph including a plurality of nodes and the graph data comprising node data associated with each node of the graph; and train a graph neural network (GNN) machine learning model using a loss equation according to a bi-level optimization problem and based on the training dataset, wherein, the one or more instructions that cause the at least one processor to train the GNN machine learning model using the loss equation according to the bi-level optimization problem, cause the at least one processor to: determine a solution to an inner loss problem, wherein, the one or more instructions that cause the at least one processor to determine the solution to the inner loss problem, cause the at least one processor to: determine a maximum value of a difference between a first loss of the GNN machine learning model based on model parameters and a second loss of the GNN machine learning model based on the model parameters and a perturbation value; determine a solution to an outer loss problem, wherein, the one or more instructions that cause the at least one processor to determine the solution to the outer loss problem, cause the at least one processor to: determine model parameters that minimize the maximum value of the difference between the first loss of the GNN machine learning model based on the model parameters and the second loss of the GNN machine learning model based on the model parameters and the perturbation value.

Further non-limiting embodiments or aspects are set forth in the following numbered clauses:

Clause 1: A computer-implemented method, comprising: receiving, with at least one processor, a training dataset comprising graph data associated with a graph, the graph comprising a plurality of nodes and the graph data comprising node data associated with each node of the graph; training, with at least one processor, a graph neural network (GNN) machine learning model using a loss equation according to a bi-level optimization problem and based on the training dataset, wherein training the GNN machine learning model using the loss equation according to the bi-level optimization problem comprises: determining a solution to an inner loss problem, wherein determining the solution to the inner loss problem comprises: determining a maximum value of a difference between a first loss of the GNN machine learning model based on model parameters and a second loss of the GNN machine learning model based on the model parameters and a perturbation value; determining a solution to an outer loss problem, wherein determining the solution to the outer loss problem comprises: determining model parameters that minimize the maximum value of the difference between the first loss of the GNN machine learning model based on the model parameters and the second loss of the GNN machine learning model based on the model parameters and the perturbation value; providing, with at least one processor, a trained GNN machine learning model based on training the GNN machine learning model.

Clause 2: The computer-implemented method of clause 1, wherein training the GNN machine learning model using the loss equation according to the bi-level optimization problem comprises: training the GNN machine learning model according to a first learning rate for the inner loss problem.

Clause 3: The computer-implemented method of clause 1 or 2, wherein training the GNN machine learning model using the loss equation according to the bi-level optimization problem comprises: training the GNN machine learning model according to a second learning rate for the outer loss problem.

Clause 4: The computer-implemented method of any of clauses 1-3, wherein determining the maximum value of the difference between the first loss of the GNN machine learning model based on the model parameters and the second loss of the GNN machine learning model based on the model parameters and the perturbation value comprises: determining, using stochastic gradient descent (SGD), the maximum value of the difference between the first loss of the GNN machine learning model based on the model parameters and the second loss of the GNN machine learning model based on the model parameters and the perturbation value.

Clause 5: The computer-implemented method of any of clauses 1-4, wherein determining the model parameters that minimize the maximum value of the difference between the first loss of the GNN machine learning model based on the model parameters and the second loss of the GNN machine learning model based on the model parameters and the perturbation value comprises: determining, using hypergradient descent, the model parameters that minimize the maximum value of the difference between the first loss of the GNN machine learning model based on the model parameters and the second loss of the GNN machine learning model based on the model parameters and the perturbation value.

Clause 6: The computer-implemented method of any of clauses 1-5, further comprising: modifying the training dataset, wherein modifying the training dataset comprises: generating a perturbation value of at least one data instance of the graph data associated with the graph.

Clause 7: The computer-implemented method of any of clauses 1-6, wherein the bi-level optimization problem comprises the following:

$${min}_{θ} \qquad {L}_{out} ( θ + ϵ )$$

$$s . t . \qquad {ϵ}^{*} ( θ ) = {arg min}_{{‖ ϵ ‖}_{2} \leq p} \qquad {L}_{i n} ( θ + ϵ )$$

$$where :$$

$${L}_{out} ( θ + ϵ ) = - {L}_{i n} ( θ + ϵ ) = L .$$

Clause 8: A system, comprising: at least one processor configured to: receive a training dataset comprising graph data associated with a graph, the graph comprising a plurality of nodes and the graph data comprising node data associated with each node of the graph; and train a graph neural network (GNN) machine learning model using a loss equation according to a bi-level optimization problem and based on the training dataset, wherein, when training the GNN machine learning model using the loss equation according to the bi-level optimization problem, the at least one processor is configured to: determine a solution to an inner loss problem, wherein, when determining the solution to the inner loss problem, the at least one processor is configured to: determine a maximum value of a difference between a first loss of the GNN machine learning model based on model parameters and a second loss of the GNN machine learning model based on the model parameters and a perturbation value; determine a solution to an outer loss problem, wherein, when determining the solution to the outer loss problem, the at least one processor is configured to: determine model parameters that minimize the maximum value of the difference between the first loss of the GNN machine learning model based on the model parameters and the second loss of the GNN machine learning model based on the model parameters and the perturbation value.

Clause 9: The system of clause 8, wherein, when training the GNN machine learning model using the loss equation according to the bi-level optimization problem, the at least one processor is configured to: train the GNN machine learning model according to a first learning rate for the inner loss problem.

Clause 10: The system of clause 8 or 9, wherein, when training the GNN machine learning model using the loss equation according to the bi-level optimization problem, the at least one processor is configured to: train the GNN machine learning model according to a second learning rate for the outer loss problem.

Clause 11: The system of any of clauses 8-10, wherein, when determining the maximum value of the difference between the first loss of the GNN machine learning model based on the model parameters and the second loss of the GNN machine learning model based on the model parameters and the perturbation value, the at least one processor is configured to: determine, using stochastic gradient descent (SGD), the maximum value of the difference between the first loss of the GNN machine learning model based on the model parameters and the second loss of the GNN machine learning model based on the model parameters and the perturbation value.

Clause 12: The system of any of clauses 8-11, wherein, when determining the model parameters that minimize the maximum value of the difference between the first loss of the GNN machine learning model based on the model parameters and the second loss of the GNN machine learning model based on the model parameters and the perturbation value, the at least one processor is configured to: determine, using hypergradient descent, the model parameters that minimize the maximum value of the difference between the first loss of the GNN machine learning model based on the model parameters and the second loss of the GNN machine learning model based on the model parameters and the perturbation value.

Clause 13: The system of any of clauses 8-12, wherein the at least one processor is further configured to: modify the training dataset, wherein, when modifying the training dataset, the at least one processor is configured to: generate a perturbation value of at least one data instance of the graph data associated with the graph.

Clause 14: The system of any of clauses 8-13, wherein the bi-level optimization problem comprises the following formula:

$${min}_{θ} \qquad {L}_{out} ( θ + ϵ )$$

$$s . t . \qquad {ϵ}^{*} ( θ ) = {arg min}_{{‖ ϵ ‖}_{2} \leq p} \qquad {L}_{i n} ( θ + ϵ )$$

$$where :$$

$${L}_{out} ( θ + ϵ ) = - {L}_{i n} ( θ + ϵ ) = L$$

Clause 15: A computer program product comprising at least one non-transitory computer-readable medium including one or more instructions that, when executed by at least one processor, cause the at least one processor to: receive a training dataset comprising graph data associated with a graph, the graph comprising a plurality of nodes and the graph data comprising node data associated with each node of the graph; and train a graph neural network (GNN) machine learning model using a loss equation according to a bi-level optimization problem and based on the training dataset, wherein, the one or more instructions that cause the at least one processor to train the GNN machine learning model using the loss equation according to the bi-level optimization problem, cause the at least one processor to: determine a solution to an inner loss problem, wherein, the one or more instructions that cause the at least one processor to determine the solution to the inner loss problem, cause the at least one processor to: determine a maximum value of a difference between a first loss of the GNN machine learning model based on model parameters and a second loss of the GNN machine learning model based on the model parameters and a perturbation value; determine a solution to an outer loss problem, wherein, the one or more instructions that cause the at least one processor to determine the solution to the outer loss problem, cause the at least one processor to: determine model parameters that minimize the maximum value of the difference between the first loss of the GNN machine learning model based on the model parameters and the second loss of the GNN machine learning model based on the model parameters and the perturbation value.

Clause 16: The computer program product of clause 15, wherein, when training the GNN machine learning model using the loss equation according to the bi-level optimization problem, the at least one processor is configured to: train the GNN machine learning model according to a first learning rate for the inner loss problem.

Clause 17: The computer program product of clause 15 or 16, wherein, when training the GNN machine learning model using the loss equation according to the bi-level optimization problem, the at least one processor is configured to: train the GNN machine learning model according to a second learning rate for the outer loss problem.

Clause 18: The computer program product of any of clauses 15-17, wherein, when determining the maximum value of the difference between the first loss of the GNN machine learning model based on the model parameters and the second loss of the GNN machine learning model based on the model parameters and the perturbation value, the at least one processor is configured to: determine, using stochastic gradient descent (SGD), the maximum value of the difference between the first loss of the GNN machine learning model based on the model parameters and the second loss of the GNN machine learning model based on the model parameters and the perturbation value.

Clause 19: The computer program product of any of clauses 15-18, wherein, when determining the model parameters that minimize the maximum value of the difference between the first loss of the GNN machine learning model based on the model parameters and the second loss of the GNN machine learning model based on the model parameters and the perturbation value, the at least one processor is configured to: determine, using hypergradient descent, the model parameters that minimize the maximum value of the difference between the first loss of the GNN machine learning model based on the model parameters and the second loss of the GNN machine learning model based on the model parameters and the perturbation value.

Clause 20: The computer program product of any of clauses 15-19, wherein the bi-level optimization problem comprises the following formula:

$${min}_{θ} \qquad {L}_{out} ( θ + ϵ )$$

$$s . t . \qquad {ϵ}^{*} ( θ ) = {arg min}_{{‖ ϵ ‖}_{2} \leq p} \qquad {L}_{i n} ( θ + ϵ )$$

$$where :$$

$${L}_{out} ( θ + ϵ ) = - {L}_{i n} ( θ + ϵ ) = L .$$

Clause 21: The computer program product of any of clauses 15-20, wherein the one or more instructions further cause the at least one processor to: modify the training dataset, wherein, the one or more instructions that cause the at least one processor to modify the training dataset, cause the at least one processor to: generate a perturbation value of at least one data instance of the graph data associated with the graph.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for optimizing training loss of a graph neural network (GNN) machine learning model using bi-level optimization, according to some non-limiting embodiments or aspects;

FIG. 2 is a flow diagram of a method for optimizing training loss of a GNN machine learning model using bi-level optimization, according to some non-limiting embodiments or aspects;

FIGS. 3A-3C are schematic diagrams of an exemplary implementation of a system and/or method for optimizing training loss of a GNN machine learning model using bi-level optimization, according to some non-limiting embodiments or aspects;

FIG. 4 is a diagram of an exemplary environment in which methods, systems, and/or computer program products, described herein, may be implemented, according to some non-limiting embodiments or aspects; and

FIG. 5 is a schematic diagram of example components of one or more devices of FIG. 1 and/or FIG. 4, according to some non-limiting embodiments or aspects.

It should be appreciated by those skilled in the art that any block diagrams herein represent conceptual views of illustrative systems embodying the principles of the present subject matter. Similarly, it may be appreciated that any flow charts, flow diagrams, state transition diagrams, pseudo code, and the like represent various processes which may be substantially represented in a computer readable medium and executed by a computer or processor, whether or not such computer or processor is explicitly shown.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the terms “issuer,” “issuer institution,” “issuer bank,” or “payment device issuer,” may refer to one or more entities that provide accounts to individuals (e.g., users, customers, and/or the like) for conducting payment transactions, such as credit payment transactions and/or debit payment transactions. For example, an issuer institution may provide an account identifier, such as a primary account number (PAN), to a customer that uniquely identifies one or more accounts associated with that customer. In some non-limiting embodiments or aspects, an issuer may be associated with a bank identification number (BIN) that uniquely identifies the issuer institution. As used herein, the term “issuer system” may refer to one or more computer systems operated by or on behalf of an issuer, such as a server executing one or more software applications. For example, an issuer system may include one or more authorization servers for authorizing a transaction.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa®, MasterCard®, American Express®, or any other entity that processes transactions. As used herein, the term “transaction service provider system” may refer to one or more computer systems operated by or on behalf of a transaction service provider, such as a transaction service provider system executing one or more software applications. A transaction service provider system may include one or more processors and, in some non-limiting embodiments or aspects, may be operated by or on behalf of a transaction service provider.

As used herein, the term “merchant” may refer to one or more entities (e.g., operators of retail businesses) that provide goods and/or services, and/or access to goods and/or services, to a user (e.g., a customer, a consumer, and/or the like) based on a transaction, such as a payment transaction. As used herein, the term “merchant system” may refer to one or more computer systems operated by or on behalf of a merchant, such as a server executing one or more software applications. As used herein, the term “product” may refer to one or more goods and/or services offered by a merchant.

As used herein, the term “acquirer” may refer to an entity licensed by the transaction service provider and approved by the transaction service provider to originate transactions (e.g., payment transactions) involving a payment device associated with the transaction service provider. As used herein, the term “acquirer system” may also refer to one or more computer systems, computer devices, and/or the like operated by or on behalf of an acquirer. The transactions the acquirer may originate may include payment transactions (e.g., purchases, original credit transactions (OCTs), account funding transactions (AFTs), and/or the like). In some non-limiting embodiments or aspects, the acquirer may be authorized by the transaction service provider to assign merchant or service providers to originate transactions involving a payment device associated with the transaction service provider. The acquirer may contract with payment facilitators to enable the payment facilitators to sponsor merchants. The acquirer may monitor the compliance of the payment facilitators in accordance with regulations of the transaction service provider. The acquirer may conduct due diligence of the payment facilitators and ensure proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by the acquirer's payment facilitators, and/or the like. In some non-limiting embodiments or aspects, an acquirer may be a financial institution, such as a bank.

Non-limiting embodiments or aspects of the present disclosure are directed to methods, systems, and computer program products for optimizing training loss of a graph neural network (GNN) machine learning model using bi-level optimization. In some non-limiting embodiments or aspects, a GNN optimization system may include at least one processor configured to receive a training dataset comprising graph data associated with a graph, the graph comprising a plurality of nodes and the graph data comprising node data associated with each node of the graph, train a graph neural network (GNN) machine learning model using a loss equation according to a bi-level optimization problem and based on the training dataset, and provide a trained GNN machine learning model based on training the GNN machine learning model.

In some non-limiting embodiments or aspects, when training the GNN machine learning model using the loss equation according to the bi-level optimization problem, the GNN optimization system may determine a solution to an inner loss problem and determine a solution to an outer loss problem. In some non-limiting embodiments or aspects, determining the solution to the inner loss problem may include determining a maximum value of a difference between a first loss of the GNN machine learning model based on the model parameters and a second loss of the GNN machine learning model based on the model parameters and a perturbation value and determining a solution to an outer loss problem. In some non-limiting embodiments or aspects, determining the solution to the outer loss problem may include determining the model parameters that minimize the maximum value of the difference between the first loss of the GNN machine learning model based on the model parameters and the second loss of the GNN machine learning model based on the model parameters and the perturbation value.

In some non-limiting embodiments or aspects, when training the GNN machine learning model using the loss equation according to the bi-level optimization problem, the GNN optimization system may train the GNN machine learning model according to a first learning rate for the inner loss problem. In some non-limiting embodiments or aspects, when training the GNN machine learning model using the loss equation according to the bi-level optimization problem, the GNN optimization system may train the GNN machine learning model according to a second learning rate for the outer loss problem.

In some non-limiting embodiments or aspects, when determining the maximum value of the difference between the first loss of the GNN machine learning model based on the model parameters and the second loss of the GNN machine learning model based on the model parameters and the perturbation value the GNN optimization system may determine, using stochastic gradient descent (SGD), the maximum value of the difference between the first loss of the GNN machine learning model based on the model parameters and the second loss of the GNN machine learning model based on the model parameters and the perturbation value. In some non-limiting embodiments or aspects, when determining the model parameters that minimize the maximum value of the difference between the first loss of the GNN machine learning model based on the model parameters and the second loss of the GNN machine learning model based on the model parameters and the perturbation value the GNN optimization system may determine, using hypergradient descent, the model parameters that minimize the maximum value of the difference between the first loss of the GNN machine learning model based on the model parameters and the second loss of the GNN machine learning model based on the model parameters and the perturbation value.

In some non-limiting embodiments or aspects, the GNN optimization system may modify the training dataset by generating a perturbation value of at least one data instance of the graph data associated with the graph.

In some non-limiting embodiments or aspects, the bi-level optimization problem may include the following:

$${min}_{θ} \qquad {L}_{out} ( θ + ϵ )$$

$$s . t . \qquad {ϵ}^{*} ( θ ) = {arg min}_{{‖ ϵ ‖}_{2} \leq p} \qquad {L}_{i n} ( θ + ϵ ) ,$$

$$where :$$

$${L}_{out} ( θ + ϵ ) = - {L}_{i n} ( θ + ϵ ) = L .$$

In this way, the GNN optimization system may provide an effective training scheme for a GNN machine learning model, which may be referred to as Sharpness-aware Graph Collaborative Filtering (SGCF). The training scheme follows the principle that a GNN machine learning model that has a flatter minima in a loss landscape (e.g., a weight loss landscape) has the better generalization ability (e.g., ability to make accurate predictions over data provided as inputs) than a GNN machine learning model that has a sharper minima in a loss landscape.

According to some non-limiting embodiments or aspects, the GNN optimization system may train a GNN machine learning model so that the GNN machine learning model is caused to converge to a minima in the loss landscape and a neighboring region of the loss landscape would have a uniformly low training loss. In some non-limiting embodiments or aspects, the GNN optimization system may regularize the flatness of the loss landscape by forming a minimax optimization problem, which includes an outer optimization problem (e.g., an outer loss problem) and an inner optimization problem (e.g., an inner loss problem). In some non-limiting embodiments or aspects, the outer optimization problem provides for training the GNN machine learning model and the inner optimization problem provides for keeping the loss landscape of the GNN machine learning model out of minima that have sharp characteristics. In some non-limiting embodiments or aspects, the GNN optimization system may utilize an implicit hypergradient to account for an interdependence between the inner and the outer optimization problems. In this way, the GNN optimization system may use an SGCF training scheme to provide a solution to the minimax optimization problem that provides improved generalization properties than a standard gradient descent calculation.

For the purpose of illustration, in the following description, while the presently disclosed subject matter is described with respect to methods, systems, and computer program products for optimizing training loss of a GNN machine learning model using bi-level optimization, one skilled in the art will recognize that the disclosed subject matter is not limited to the non-limiting embodiments or aspects disclosed herein. For example, the methods, systems, and computer program products described herein may be used with a wide variety of settings, such as generating a GNN machine learning model based on graph data in any suitable setting, e.g., predictions, regressions, classifications, fraud prevention, authorization, authentication, identification, feature selection, recommendations, and/or the like.

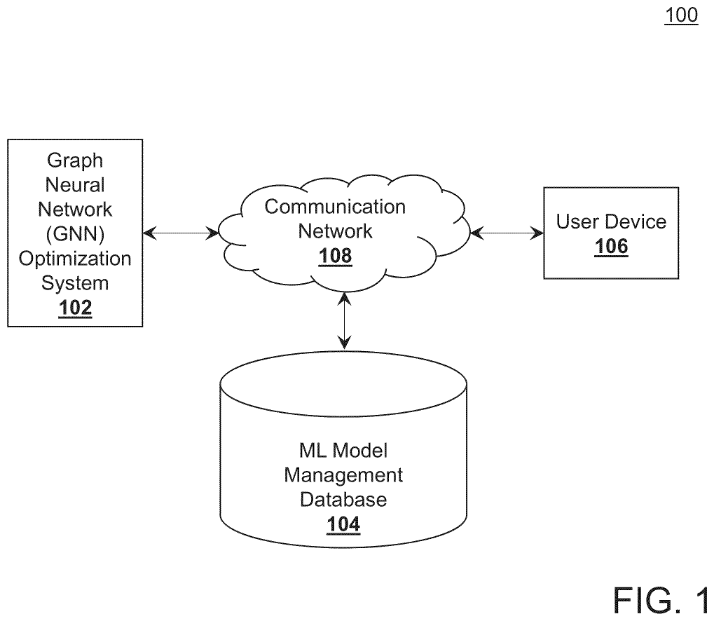

Referring now to FIG. 1, shown is a diagram of example environment 100 in which devices, systems, and/or methods, described herein, may be implemented. As shown in FIG. 1, environment 100 includes graph neural network (GNN) optimization system 102, machine learning (ML) model management database 104, user device 106, and communication network 108. GNN optimization system 102, ML model management database 104, and/or user device 106 may interconnect (e.g., establish a connection to communicate) via wired connections, wireless connections, or a combination of wired and wireless connections.

GNN optimization system 102 may include one or more devices configured to communicate with ML model management database 104 and/or user device 106 via communication network 108. For example, GNN optimization system 102 may include a server, a group of servers, and/or other like devices. In some non-limiting embodiments or aspects, GNN optimization system 102 may be associated with a transaction service provider system. For example, GNN optimization system 102 may be operated by the transaction service provider system. In another example, GNN optimization system 102 may be a component of ML model management database 104. In some non-limiting embodiments or aspects, GNN optimization system 102 may be in communication with a data storage device, which may be local or remote to GNN optimization system 102. In some non-limiting embodiments or aspects, GNN optimization system 102 may be capable of receiving information from, storing information in, transmitting information to, and/or searching information stored in the data storage device.

ML model management database 104 may include one or more devices capable of receiving information from and/or communicating information to GNN optimization system 102 and/or user device 106 (e.g., directly via wired or wireless communication connection, indirectly via communication network 108, and/or the like). For example, ML model management database 104 may include a computing device, such as a server, a group of servers, a desktop computer, a portable computer, a mobile device, and/or other like devices. In some non-limiting embodiments or aspects, ML model management database 104 may include a data storage device. In some non-limiting embodiments or aspects, ML model management database 104 may be capable of receiving information from, storing information in, communicating information to, or searching information stored in the data storage device. In some non-limiting embodiments or aspects, ML model management database 104 may be part of GNN optimization system 102 and/or part of the same system as GNN optimization system 102.

User device 106 may include a computing device configured to communicate with GNN optimization system 102 and/or ML model management database 104 via communication network 108. For example, user device 106 may include a computing device, such as a desktop computer, a portable computer (e.g., tablet computer, a laptop computer, and/or the like), a mobile device (e.g., a cellular phone, a smartphone, a personal digital assistant, a wearable device, and/or the like), and/or other like devices. In some non-limiting embodiments or aspects, user device 106 may be associated with a user (e.g., an individual operating user device 106).

Communication network 108 may include one or more wired and/or wireless networks. For example, communication network 108 may include a cellular network (e.g., a long-term evolution (LTE) network, a third-generation (3G) network, a fourth-generation (4G) network, a fifth-generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN) and/or the like), a private network, an ad hoc network, an intranet, the Internet, a fiber optic-based network, a cloud computing network, and/or the like, and/or a combination of some or all of these or other types of networks.

The number and arrangement of devices and networks shown in FIG. 1 are provided as an example. There may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally or alternatively, a set of devices (e.g., one or more devices) of environment 100 may perform one or more functions described as being performed by another set of devices of environment 100.

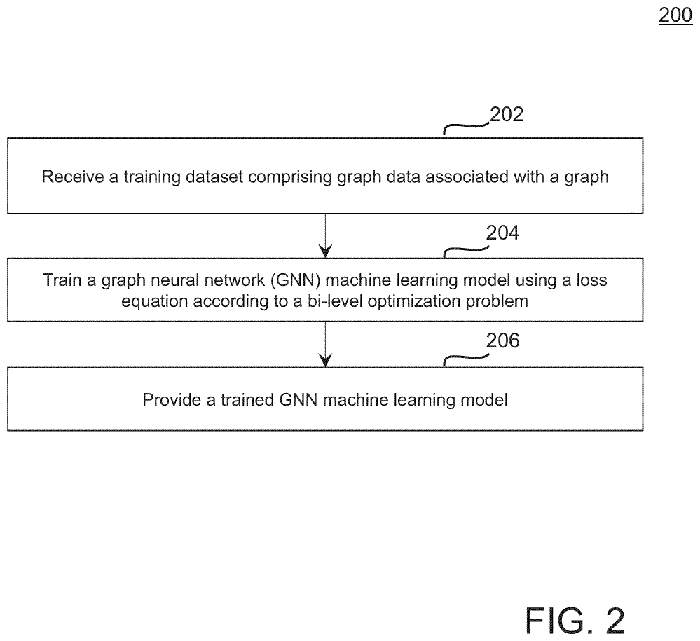

Referring now to FIG. 2, shown is a flow diagram of a non-limiting embodiment or aspect of process 200 for optimizing training loss of a GNN machine learning model using bi-level optimization. In some non-limiting embodiments or aspects, one or more of the steps of process 200 may be performed (e.g., completely, partially, etc.) by GNN optimization system 102 (e.g., one or more devices of GNN optimization system 102). In some non-limiting embodiments or aspects, one or more of the steps of process 200 may be performed (e.g., completely, partially, etc.) by another device or a group of devices separate from or including GNN optimization system 102 (e.g., one or more devices of GNN optimization system 102), ML model management database 104 (e.g., one or more devices of ML model management database 104), and/or user device 106.

As shown in FIG. 2, at step 202, process 200 includes receiving a training dataset comprising graph data associated with a graph. For example, GNN optimization system 102 may receive a training dataset comprising graph data associated with a graph (e.g., a mathematical structure used to model pairwise relations between objects). In some non-limiting embodiments or aspects, the graph may include a plurality of nodes and a plurality of edges. In some non-limiting embodiments or aspects, the graph data may include node data associated with each node (e.g., vertex) and/or edge data associated with each edge (e.g., links) of the graph. In some non-limiting embodiments or aspects, GNN optimization system 102 may receive the training dataset from ML model management database 104, user device 106, and/or another device or system.

In some non-limiting embodiments or aspects, the training dataset may include graph data associated with a set of nodes (e.g., a set of at least 5, 10, 15, 30, 50, 100, 200, 300, etc., or more nodes). In some non-limiting embodiments or aspects, the training dataset may include graph data associated with a set of labeled nodes and/or a set of unlabeled nodes. In some non-limiting embodiments or aspects, the graph data may include a plurality of node embeddings associated with a number of nodes in the graph and node data associated with each node of the graph. The node data may include data associated with parameters of each node in the graph. Additionally or alternatively, the node data may include user data associated with a plurality of users and/or entity data associated with a plurality of entities. The plurality of node embeddings may include a first set of node embeddings and/or a second set of node embeddings. The first set of node embeddings may be based on the user data and/or the second set of node embeddings may be based on the entity data.

In some non-limiting embodiments or aspects, the node data may include data associated with parameters of each node in the graph. In some non-limiting embodiments or aspects, the dataset may be associated with a population of entities (e.g., users, accountholders, merchants, issuers, etc.) that includes a plurality of data instances associated with a plurality of features. In some non-limiting embodiments or aspects, the plurality of data instances may represent a plurality of transactions (e.g., electronic payment transactions) conducted by the population. In some examples, the training dataset may include a large amount of data instances, such as 100 data instances, 500 data instances, 1,000 data instances, 5,000 data instances, 10,000 data instances, 25,000 data instances, 50,000 data instances, 100,000 data instances, 1,000,000 data instances, and/or the like.

In some non-limiting embodiments or aspects, each data instance may include transaction data associated with the transaction. In some non-limiting embodiments or aspects, the transaction data may include a plurality of transaction parameters associated with an electronic payment transaction. In some non-limiting embodiments or aspects, the plurality of features may represent the plurality of transaction parameters. In some non-limiting embodiments or aspects, the plurality of transaction parameters may include electronic wallet card data associated with an electronic card (e.g., an electronic credit card, an electronic debit card, an electronic loyalty card, and/or the like), decision data associated with a decision (e.g., a decision to approve or deny a transaction authorization request), authorization data associated with an authorization response (e.g., an approved spending limit, an approved transaction value, and/or the like), a primary account number (PAN), an authorization code (e.g., a personal identification number (PIN), etc.), data associated with a transaction amount (e.g., an approved limit, a transaction value, etc.), data associated with a transaction date and time, data associated with a conversion rate of a currency, data associated with a merchant type (e.g., a merchant category code that indicates a type of goods, such as grocery, fuel, and/or the like), data associated with an acquiring institution country, data associated with an identifier of a country associated with the PAN, data associated with a response code, data associated with a merchant identifier (e.g., a merchant name, a merchant location, and/or the like), data associated with a type of currency corresponding to funds stored in association with the PAN, and/or the like.

As shown in FIG. 2, at step 204, process 200 includes training a GNN machine learning model using a loss equation according to a bi-level optimization problem. For example, GNN optimization system 102 may train a GNN machine learning model using a loss equation according to a bi-level optimization problem. In some non-limiting embodiments or aspects, the bi-level optimization problem may include an inner loss problem and an outer loss problem.

In some non-limiting embodiments or aspects, a generalization bound based on sharpness of a loss landscape may be provided by the formula, for any ρ>0 and any distribution D, with probability 1−δ over the choice of a training dataset S˜D:

$${L}_{D} ( θ ) \leq {max}_{{‖ ϵ ‖}_{2} \leq ρ} {L}_{𝒮} ( θ + ϵ ) + \sqrt{\frac{k log ( 1 + \frac{{‖ θ ‖}_{2}^{2}}{{ρ}^{2}} {( 1 + \sqrt{\frac{log ( n )}{k}} )}^{2} ) + 4 log \frac{n}{δ} + \tilde{O} ( 1 )}{n - 1}}$$

where n=|S| and k is the number of model parameters of the GNN machine learning model (e.g., weights and coefficients of the GNN machine learning model). In some non-limiting embodiments or aspects, the following condition may be assumed:

$${L}_{D} ( θ ) \leq {𝔼}_{{ϵ}_{i} \sim ( 0 , ρ )} [ {L}_{D} ( θ + ϵ ) ]$$

In some non-limiting embodiments or aspects, the condition provides that adding a Gaussian perturbation should not decrease a test error for the GNN machine learning model. Based on the above formula, a sharpness of a loss function for the GNN machine learning model may be defined as:

$${max}_{{‖ ϵ ‖}_{2} \leq ρ} ℒ ( θ + ϵ ) - ℒ ( θ )$$

In some non-limiting embodiments or aspects, a sharpness-aware minimization problem may be defined as the following minimax optimization:

$${min}_{θ} {max}_{{‖ ϵ ‖}_{2} \leq ρ} L ( θ + ϵ )$$

In some non-limiting embodiments or aspects, the bi-level optimization problem comprises the following formula, which includes an outer loss problem (e.g., with regard to Lₒᵤₜ) and an inner loss problem (e.g., with regard to Lᵢₙ):

$${min}_{θ} {L}_{out} ( θ + ϵ ) \\ s . t . {ϵ}^{*} ( θ ) = {arg min}_{{‖ ϵ ‖}_{2} \leq ρ} {L}_{in} ( θ + ϵ ) \\ where : \\ {L}_{out} ( θ + ϵ ) = - {L}_{in} ( θ + ϵ ) = L .$$

In some non-limiting embodiments or aspects, GNN optimization system 102 may determine a solution to an inner loss problem. For example, GNN optimization system 102 may determine a solution to the inner loss problem by determining (e.g., using stochastic gradient descent (SGD)) a maximum value of a difference between a first loss of the GNN machine learning model based on the model parameters and a second loss of the GNN machine learning model based on the model parameters and a perturbation value.

In some non-limiting embodiments or aspects, GNN optimization system 102 may determine a solution to an outer loss problem, where determining a solution to the outer loss problem may include determining (e.g., using hypergradient descent) the model parameters that minimize the maximum value of the difference between the first loss of the GNN machine learning model based on the model parameters and the second loss of the GNN machine learning model based on the model parameters and the perturbation value.

In some non-limiting embodiments or aspects, when training the GNN machine learning model using the loss equation according to the bi-level optimization problem, GNN optimization system 102 may train the GNN machine learning model according to a first learning rate for the inner loss problem. In some non-limiting embodiments or aspects, when training the GNN machine learning model using the loss equation according to the bi-level optimization problem, GNN optimization system 102 may train the GNN machine learning model according to a second learning rate for the outer loss problem.

In some non-limiting embodiments or aspects, with regard to the inner loss problem, GNN optimization system 102 may use SGD to optimize inner variables of the following equation:

$${ϵ}_{θ , t + 1} = {ϵ}_{θ , t} - {α}_{t} {∇}_{ϵ} {L}_{in} ( {ϵ}_{θ , t} , θ )$$

where αₜ is an inner learning rate (e.g., a first learning rate) for the inner loss problem.

In some non-limiting embodiments or aspects, with regard to the outer loss problem, GNN optimization system 102 may perform a hypergradient descent procedure to update the outer loss problem according to the following equation:

$${θ}_{t + 1} \vert = {θ}_{t} - {β}_{t} {∇}_{θ} {L}_{out} ( {ϵ}_{θ , T} , θ )$$

where βₜ is the outer learning rate (e.g., a second learning rate) for the outer loss problem. In some non-limiting embodiments or aspects, after T iterations, ϵ_{θ,T} may be a minimizer of the loss function of the outer loss problem, Lₒᵤₜ, with fixed graph generator parameter θ, the hypergradient, ∇_{θ}Lₒᵤₜ, can be calculated according to the following equation:

$${{∇}_{θ} {L}_{out} ( {ϵ}_{θ , T} , θ ) = ( \frac{\partial {L}_{out} ( ϵ , θ )}{\partial θ} + \frac{\partial {L}_{out} ( ϵ , θ )}{\partial ϵ} * \frac{\partial ϵ}{\partial θ} ) \vert}_{( {ϵ}_{θ , T} , θ )}$$

The above equation illustrates that the calculation of the hypergradient consists of two parts: direct gradient (e.g., the first item) and indirect gradient (e.g., the second item). In some non-limiting embodiments or aspects, calculating the indirect gradient may require calculating indirect gradient for the parameter Jacobian ∂ϵ/∂θ, to account for how the optimal parameters E change with respect to θ. In some non-limiting embodiments or aspects, the parameter Jacobian ∂ϵ/∂θ may be replaced with a product of the inverse Hessian matrix and the mixed partial derivative according to the following equation:

$${{\frac{\partial ϵ}{\partial θ} \vert}_{( {ϵ}^{′} , {θ}^{′} )} = [ - {( \frac{{\partial }^{2} {L}_{in} ( ϵ , θ )}{\partial ϵ \partial ϵ} )}^{- 1} * \frac{{\partial }^{2} {L}_{in} ( ϵ , θ )}{\partial ϵ \partial θ} ] \vert}_{( {ϵ}^{′} , {θ}^{′} )}$$

In some non-limiting embodiments or aspects, the inverse Hessian matrix may be estimated according to the following equation:

$$\begin{matrix}{( \frac{{\partial }^{2} {L}_{in}}{\partial ϵ \partial ϵ} )}^{- 1} = γ * {[ I - ( I - γ * \frac{{\partial }^{2} {L}_{in}}{\partial ϵ \partial ϵ} ) ]}^{- 1} \\ = {lim}_{i ∈ ∞} γ * {\sum }_{j = 0}^{i} {( I - γ * \frac{{\partial }^{2} {L}_{in}}{\partial ϵ \partial ϵ} )}^{j}\end{matrix}$$

In some non-limiting embodiments or aspects, given the above, GNN optimization system 102 may calculate a final hypergradient (e.g., an approximation of a final hypergradient) according to the following equation:

$${∇}_{θ} {L}_{out} ( {ϵ}_{θ , T} , θ ) \approx$$

$${[ \frac{\partial {L}_{out} ( ϵ , θ )}{\partial θ} - \frac{\partial {L}_{out} ( ϵ , θ )}{\partial ϵ} * γ {\sum }_{j = 0}^{K} {( I - γ * \frac{{\partial }^{2} {L}_{in} ( ϵ , θ )}{\partial ϵ \partial ϵ} )}^{j} * \frac{{\partial }^{2} {L}_{in} ( ϵ , θ )}{\partial ϵ \partial θ} ] \vert}_{( {ϵ}_{θ , γ} , θ )}$$

In some non-limiting embodiments or aspects, GNN optimization system 102 may modify the training dataset. For example, GNN optimization system 102 may modify the training dataset by generating a perturbation value of at least one data instance of the graph data associated with the graph. In some non-limiting embodiments or aspects, GNN optimization system 102 may modify the training dataset by generating a perturbation value of all data instances of the graph data associated with the graph.

In some non-limiting embodiments or aspects, GNN optimization system 102 may validate and/or test the trained GNN machine learning model based on the training dataset and/or a modified training dataset.

As shown in FIG. 2, at step 206, process 200 includes providing a trained GNN machine learning model. For example, GNN optimization system 102 may provide a trained GNN machine learning model to user device 106 and/or other device or system, based on training the GNN machine learning model. In some non-limiting embodiments or aspects, GNN optimization system 102 may train a GNN based on a set of graph features (e.g., features associated with a graph, such as features included in graph data) to provide the trained GNN machine learning model.

In some non-limiting embodiments or aspects, GNN optimization system 102 may perform an action, such as a fraud prevention procedure, a creditworthiness procedure, and/or a recommendation procedure, using a trained GNN machine learning model. In some non-limiting embodiments or aspects, GNN optimization system 102 may perform a fraud prevention procedure associated with protection of an account of a user (e.g., a user associated with user device 106) based on an output of the trained GNN machine learning model (e.g., an output that includes a prediction regarding whether a node of a graph is an anomaly). For example, if the output of the trained machine learning model indicates that the fraud prevention procedure is necessary, GNN optimization system 102 may perform the fraud prevention procedure associated with protection of the account of the user. In such an example, if the output of the trained machine learning model indicates that the fraud prevention procedure is not necessary, GNN optimization system 102 may forego performing the fraud prevention procedure associated with protection of the account of the user. In some non-limiting embodiments or aspects, GNN optimization system 102 may execute a fraud prevention procedure based on a classification of an input as provided by the GNN machine learning model.

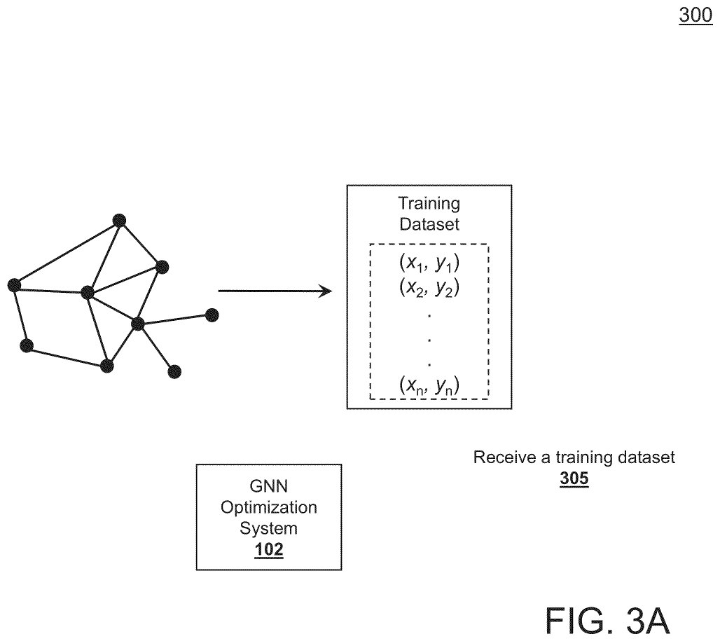

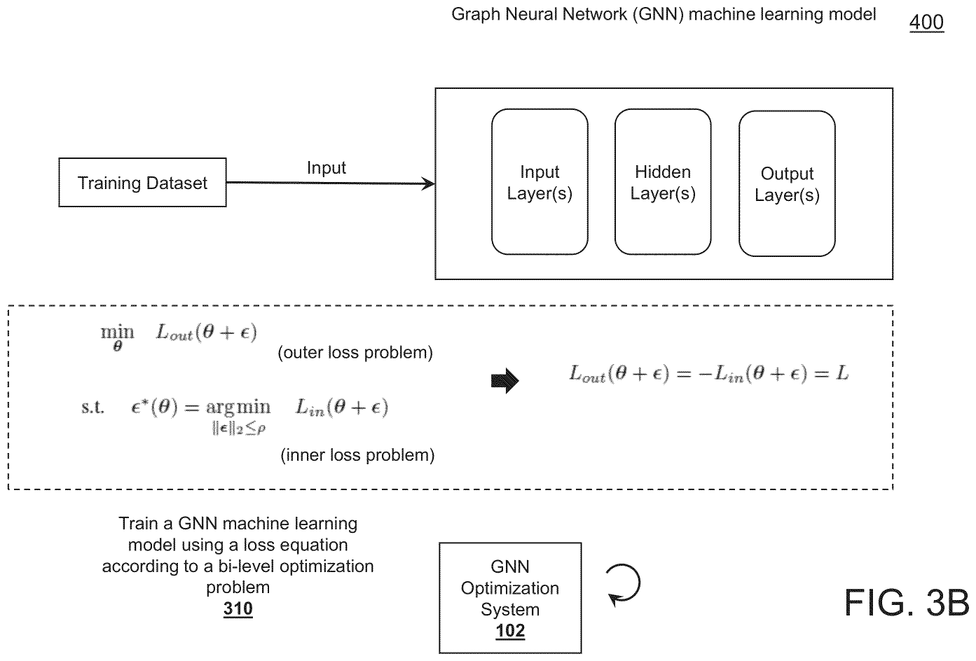

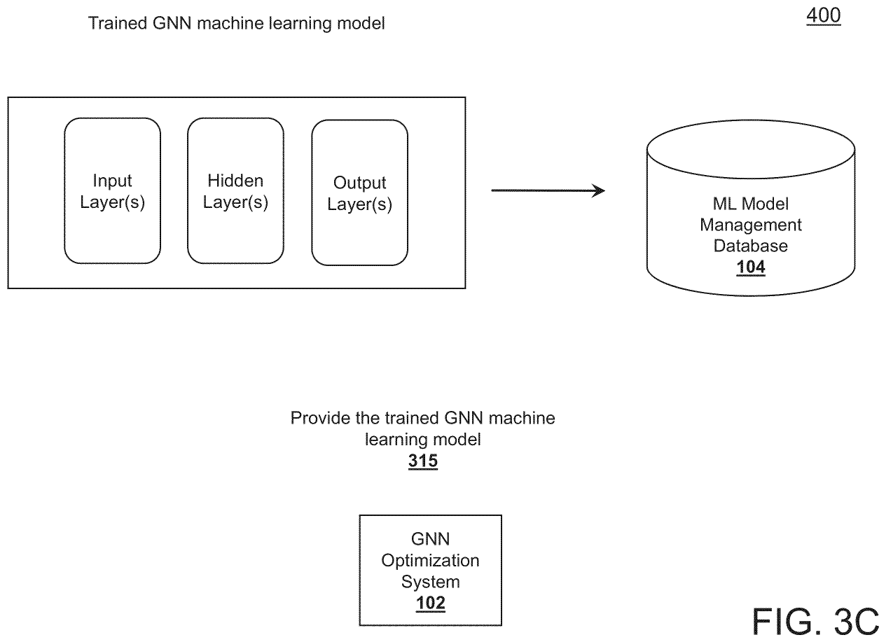

Referring now to FIGS. 3A-3C, shown are schematic diagrams of implementation 300 of a process (e.g., process 200) for optimizing training loss of a GNN machine learning model using bi-level optimization. In some non-limiting embodiments or aspects, one or more of the steps of the process may be performed (e.g., completely, partially, etc.) by GNN optimization system 102 (e.g., one or more devices of GNN optimization system 102). In some non-limiting embodiments or aspects, one or more of the steps of the process may be performed (e.g., completely, partially, etc.) by another device or a group of devices separate from or including GNN optimization system 102 (e.g., one or more devices of GNN optimization system 102), ML model management database 104, and/or user device 106.

As shown by reference number 305 in FIG. 3A, GNN optimization system 102 may receive a training dataset. For example, GNN optimization system 102 may receive a training dataset comprising graph data associated with a graph. In some non-limiting embodiments or aspects, the graph may include a plurality of nodes and a plurality of edges. In some non-limiting embodiments or aspects, the graph data may include node data associated with each node (e.g., vertex) and/or edge data associated with each edge (e.g., links) of the graph. In some non-limiting embodiments or aspects, GNN optimization system 102 may receive the training dataset from ML model management database 104, user device 106, and/or another device or system.

As shown by reference number 310 in FIG. 3B, GNN optimization system 102 may train a GNN machine learning model using a loss equation according to a bi-level optimization problem. In some non-limiting embodiments or aspects, the GNN machine learning model may include one or more input layers, one or more hidden layers, and/or one or more output layers. In one example, the GNN machine learning model may include a neural network machine learning model having a large number of nodes. In some non-limiting embodiments or aspects, the GNN machine learning model may include a neural network machine learning model having 10 nodes, 20 nodes, 50 nodes, 100 nodes, 1,000 nodes, and/or the like.

In some non-limiting embodiments or aspects, the bi-level optimization problem may include an inner loss problem and an outer loss problem. In some non-limiting embodiments or aspects, the bi-level optimization problem comprises the following formula, which includes an outer loss problem (e.g., with regard to Lₒᵤₜ) and an inner loss problem (e.g., with regard to Lᵢₙ):

$${min}_{θ} {L}_{out} ( θ + ϵ ) \\ s . t . {ϵ}^{*} ( θ ) = {arg min}_{{‖ ϵ ‖}_{2} \leq ρ} {L}_{in} ( θ + ϵ ) \\ where : \\ {L}_{out} ( θ + ϵ ) = - {L}_{in} ( θ + ϵ ) = L .$$

In some non-limiting embodiments or aspects, GNN optimization system 102 may determine a solution to an inner loss problem. For example, GNN optimization system 102 may determine a solution to the inner loss problem by determining (e.g., using SGD) a maximum value of a difference between a first loss of the GNN machine learning model based on the model parameters and a second loss of the GNN machine learning model based on the model parameters and a perturbation value. In some non-limiting embodiments or aspects, GNN optimization system 102 may determine a solution to an outer loss problem, where determining a solution to the outer loss problem may include determining (e.g., using hypergradient descent) the model parameters that minimize the maximum value of the difference between the first loss of the GNN machine learning model based on the model parameters and the second loss of the GNN machine learning model based on the model parameters and the perturbation value.

As shown by reference number 315 in FIG. 3C, GNN optimization system 102 may provide the trained GNN machine learning model. For example, GNN optimization system 102 may provide the trained GNN machine learning model to ML model management database 104 based on training the trained GNN machine learning model.

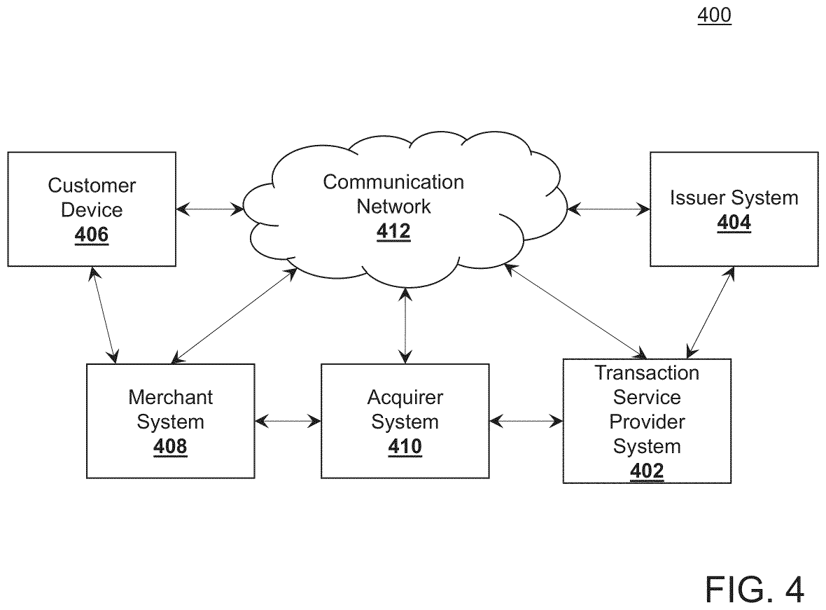

Referring now to FIG. 4, shown is a diagram of a non-limiting embodiment or aspect of environment 400 in which systems, products, and/or methods, as described herein, may be implemented. As shown in FIG. 4, environment 400 may include transaction service provider system 402, issuer system 404, customer device 406, merchant system 408, acquirer system 410, and communication network 412. In some non-limiting embodiments or aspects, each of GNN optimization system 102, ML model management database 104, and/or user device 106 of FIG. 1 may be implemented by (e.g., part of) transaction service provider system 402. In some non-limiting embodiments or aspects, at least one of GNN optimization system 102, ML model management database 104, and/or user device 106 of FIG. 1 may be implemented by (e.g., part of) another system, another device, another group of systems, or another group of devices, separate from or including transaction service provider system 402, such as issuer system 404, customer device 406, merchant system 408, acquirer system 410, and/or the like.

Transaction service provider system 402 may include one or more devices capable of receiving information from and/or communicating information to issuer system 404, customer device 406, merchant system 408, and/or acquirer system 410 via communication network 412. For example, transaction service provider system 402 may include a computing device, such as a server (e.g., a transaction processing server), a group of servers, and/or other like devices. In some non-limiting embodiments or aspects, transaction service provider system 402 may be associated with a transaction service provider as described herein. In some non-limiting embodiments or aspects, transaction service provider system 402 may be in communication with a data storage device, which may be local or remote to transaction service provider system 402. In some non-limiting embodiments or aspects, transaction service provider system 402 may be capable of receiving information from, storing information in, communicating information to, or searching information stored in the data storage device.

Issuer system 404 may include one or more devices capable of receiving information and/or communicating information to transaction service provider system 402, customer device 406, merchant system 408, and/or acquirer system 410 via communication network 412. For example, issuer system 404 may include a computing device, such as a server, a group of servers, and/or other like devices. In some non-limiting embodiments or aspects, issuer system 404 may be associated with an issuer institution as described herein. For example, issuer system 404 may be associated with an issuer institution that issued a credit account, debit account, credit card, debit card, and/or the like to a user associated with customer device 406.

Customer device 406 may include one or more devices capable of receiving information from and/or communicating information to transaction service provider system 402, issuer system 404, merchant system 408, and/or acquirer system 410 via communication network 412. Additionally or alternatively, each customer device 406 may include a device capable of receiving information from and/or communicating information to other customer devices 406 via communication network 412, another network (e.g., an ad hoc network, a local network, a private network, a virtual private network, and/or the like), and/or any other suitable communication technique. For example, customer device 406 may include a client device and/or the like. In some non-limiting embodiments or aspects, customer device 406 may or may not be capable of receiving information (e.g., from merchant system 408 or from another customer device 406) via a short-range wireless communication connection (e.g., a near field communication (NFC) connection, a radio frequency identification (RFID) communication connection, a Bluetooth® communication connection, a Zigbee® communication connection, and/or the like), and/or communicating information (e.g., to merchant system 408) via a short-range wireless communication connection.

Merchant system 408 may include one or more devices capable of receiving information from and/or communicating information to transaction service provider system 402, issuer system 404, customer device 406, and/or acquirer system 410 via communication network 412. Merchant system 408 may also include a device capable of receiving information from customer device 406 via communication network 412, a communication connection (e.g., an NFC connection, an RFID communication connection, a Bluetooth® communication connection, a Zigbee® communication connection, and/or the like) with customer device 406, and/or the like, and/or communicating information to customer device 406 via communication network 412, the communication connection, and/or the like. In some non-limiting embodiments or aspects, merchant system 408 may include a computing device, such as a server, a group of servers, a client device, a group of client devices, and/or other like devices. In some non-limiting embodiments or aspects, merchant system 408 may be associated with a merchant as described herein. In some non-limiting embodiments or aspects, merchant system 408 may include one or more client devices. For example, merchant system 408 may include a client device that allows a merchant to communicate information to transaction service provider system 402. In some non-limiting embodiments or aspects, merchant system 408 may include one or more devices, such as computers, computer systems, and/or peripheral devices capable of being used by a merchant to conduct a transaction with a user. For example, merchant system 408 may include a POS device and/or a POS system.

Acquirer system 410 may include one or more devices capable of receiving information from and/or communicating information to transaction service provider system 402, issuer system 404, customer device 406, and/or merchant system 408 via communication network 412. For example, acquirer system 410 may include a computing device, a server, a group of servers, and/or the like. In some non-limiting embodiments or aspects, acquirer system 410 may be associated with an acquirer as described herein.

Communication network 412 may include one or more wired and/or wireless networks. For example, communication network 412 may include a cellular network (e.g., a long-term evolution (LTE) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

The number and arrangement of systems, devices, and/or networks shown in FIG. 4 are provided as an example. There may be additional systems, devices, and/or networks; fewer systems, devices, and/or networks; different systems, devices, and/or networks; and/or differently arranged systems, devices, and/or networks than those shown in FIG. 4. Furthermore, two or more systems or devices shown in FIG. 4 may be implemented within a single system or device, or a single system or device shown in FIG. 4 may be implemented as multiple, distributed systems or devices. Additionally or alternatively, a set of systems (e.g., one or more systems) or a set of devices (e.g., one or more devices) of environment 400 may perform one or more functions described as being performed by another set of systems or another set of devices of environment 400.

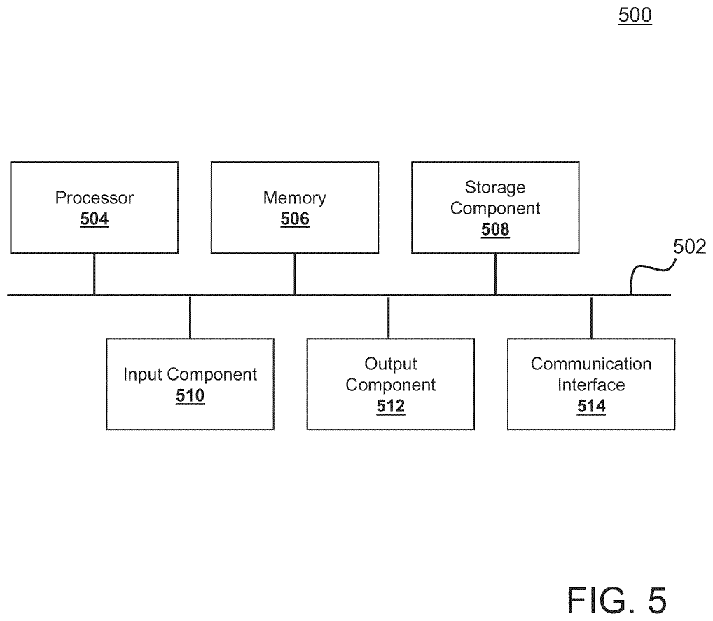

Referring now to FIG. 5, shown is a diagram of example components of device 500, according to non-limiting embodiments or aspects. Device 500 may correspond to at least one of GNN optimization system 102, ML model management database 104, and/or user device 106 in FIG. 1 and/or at least one of transaction service provider system 402, issuer system 404, customer device 406, merchant system 408, and/or acquirer system 410 in FIG. 4, as an example. In some non-limiting embodiments or aspects, such systems or devices in FIG. 1 or FIG. 4 may include at least one device 500 and/or at least one component of device 500. The number and arrangement of components shown in FIG. 5 are provided as an example. In some non-limiting embodiments or aspects, device 500 may include additional components, fewer components, different components, or differently arranged components than those shown in FIG. 5. Additionally or alternatively, a set of components (e.g., one or more components) of device 500 may perform one or more functions described as being performed by another set of components of device 500.

As shown in FIG. 5, device 500 may include bus 502, processor 504, memory 506, storage component 508, input component 510, output component 512, and communication interface 514. Bus 502 may include a component that permits communication among the components of device 500. In some non-limiting embodiments or aspects, processor 504 may be implemented in hardware, firmware, or a combination of hardware and software. For example, processor 504 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 506 may include random access memory (RAM), read only memory (ROM), and/or another type of dynamic or static storage device (e.g., flash memory, magnetic memory, optical memory, etc.) that stores information and/or instructions for use by processor 504.

With continued reference to FIG. 5, storage component 508 may store information and/or software related to the operation and use of device 500. For example, storage component 508 may include a hard disk (e.g., a magnetic disk, an optical disk, a magneto-optic disk, a solid state disk, etc.) and/or another type of computer-readable medium. Input component 510 may include a component that permits device 500 to receive information, such as via user input (e.g., a touch screen display, a keyboard, a keypad, a mouse, a button, a switch, a microphone, etc.). Additionally or alternatively, input component 510 may include a sensor for sensing information (e.g., a global positioning system (GPS) component, an accelerometer, a gyroscope, an actuator, etc.). Output component 512 may include a component that provides output information from device 500 (e.g., a display, a speaker, one or more light-emitting diodes (LEDs), etc.). Communication interface 514 may include a transceiver-like component (e.g., a transceiver, a separate receiver and transmitter, etc.) that enables device 500 to communicate with other devices, such as via a wired connection, a wireless connection, or a combination of wired and wireless connections. Communication interface 514 may permit device 500 to receive information from another device and/or provide information to another device. For example, communication interface 514 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 500 may perform one or more processes described herein. Device 500 may perform these processes based on processor 504 executing software instructions stored by a computer-readable medium, such as memory 506 and/or storage component 508. A computer-readable medium may include any non-transitory memory device. A memory device includes memory space located inside of a single physical storage device or memory space spread across multiple physical storage devices. Software instructions may be read into memory 506 and/or storage component 508 from another computer-readable medium or from another device via communication interface 514. When executed, software instructions stored in memory 506 and/or storage component 508 may cause processor 504 to perform one or more processes described herein. Additionally or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A computer-implemented method, comprising:
receiving, with at least one processor, a training dataset comprising graph data associated with a graph, the graph comprising a plurality of nodes and the graph data comprising node data associated with each node of the graph;
training, with at least one processor, a graph neural network (GNN) machine learning model using a loss equation according to a bi-level optimization problem and based on the training dataset, wherein training the GNN machine learning model using the loss equation according to the bi-level optimization problem comprises:
determining a solution to an inner loss problem, wherein determining the solution to the inner loss problem comprises:
determining a maximum value of a difference between a first loss of the GNN machine learning model based on model parameters and a second loss of the GNN machine learning model based on the model parameters and a perturbation value;
determining a solution to an outer loss problem, wherein determining the solution to the outer loss problem comprises:
determining model parameters that minimize the maximum value of the difference between the first loss of the GNN machine learning model based on the model parameters and the second loss of the GNN machine learning model based on the model parameters and the perturbation value; and
providing, with at least one processor, a trained GNN machine learning model based on training the GNN machine learning model.

2. The computer-implemented method of claim 1, wherein training the GNN machine learning model using the loss equation according to the bi-level optimization problem comprises:
training the GNN machine learning model according to a first learning rate for the inner loss problem.

3. The computer-implemented method of claim 1, wherein training the GNN machine learning model using the loss equation according to the bi-level optimization problem comprises:
training the GNN machine learning model according to a second learning rate for the outer loss problem.

4. The computer-implemented method of claim 1, wherein determining the maximum value of the difference between the first loss of the GNN machine learning model based on the model parameters and the second loss of the GNN machine learning model based on the model parameters and the perturbation value comprises:
determining, using stochastic gradient descent (SGD), the maximum value of the difference between the first loss of the GNN machine learning model based on the model parameters and the second loss of the GNN machine learning model based on the model parameters and the perturbation value.

5. The computer-implemented method of claim 1, wherein determining the model parameters that minimize the maximum value of the difference between the first loss of the GNN machine learning model based on the model parameters and the second loss of the GNN machine learning model based on the model parameters and the perturbation value comprises:
determining, using hypergradient descent, the model parameters that minimize the maximum value of the difference between the first loss of the GNN machine learning model based on the model parameters and the second loss of the GNN machine learning model based on the model parameters and the perturbation value.

6. The computer-implemented method of claim 1, further comprising:
modifying the training dataset, wherein modifying the training dataset comprises:
generating a perturbation value of at least one data instance of the graph data associated with the graph.

7. The computer-implemented method of claim 1, wherein the bi-level optimization problem comprises the following:
$${min}_{θ} {L}_{out} ( θ + ϵ ) \\ s . t . {ϵ}^{*} ( θ ) = {arg min}_{{‖ ϵ ‖}_{2} \leq ρ} {L}_{in} ( θ + ϵ ) \\ where : \\ {L}_{out} ( θ + ϵ ) = - {L}_{in} ( θ + ϵ ) = L .$$

8. A system, comprising:
at least one processor configured to:
receive a training dataset comprising graph data associated with a graph, the graph comprising a plurality of nodes and the graph data comprising node data associated with each node of the graph; and
train a graph neural network (GNN) machine learning model using a loss equation according to a bi-level optimization problem and based on the training dataset, wherein, when training the GNN machine learning model using the loss equation according to the bi-level optimization problem, the at least one processor is configured to:
determine a solution to an inner loss problem, wherein, when determining the solution to the inner loss problem, the at least one processor is configured to:
determine a maximum value of a difference between a first loss of the GNN machine learning model based on model parameters and a second loss of the GNN machine learning model based on the model parameters and a perturbation value;
determine a solution to an outer loss problem, wherein, when determining the solution to the outer loss problem, the at least one processor is configured to:
determine model parameters that minimize the maximum value of the difference between the first loss of the GNN machine learning model based on the model parameters and the second loss of the GNN machine learning model based on the model parameters and the perturbation value.

9. The system of claim 8, wherein, when training the GNN machine learning model using the loss equation according to the bi-level optimization problem, the at least one processor is configured to:
train the GNN machine learning model according to a first learning rate for the inner loss problem.

10. The system of claim 8, wherein, when training the GNN machine learning model using the loss equation according to the bi-level optimization problem, the at least one processor is configured to:
train the GNN machine learning model according to a second learning rate for the outer loss problem.

11. The system of claim 8, wherein, when determining the maximum value of the difference between the first loss of the GNN machine learning model based on the model parameters and the second loss of the GNN machine learning model based on the model parameters and the perturbation value, the at least one processor is configured to:
determine, using stochastic gradient descent (SGD), the maximum value of the difference between the first loss of the GNN machine learning model based on the model parameters and the second loss of the GNN machine learning model based on the model parameters and the perturbation value.

12. The system of claim 8, wherein, when determining the model parameters that minimize the maximum value of the difference between the first loss of the GNN machine learning model based on the model parameters and the second loss of the GNN machine learning model based on the model parameters and the perturbation value, the at least one processor is configured to:
determine, using hypergradient descent, the model parameters that minimize the maximum value of the difference between the first loss of the GNN machine learning model based on the model parameters and the second loss of the GNN machine learning model based on the model parameters and the perturbation value.

13. The system of claim 8, wherein the at least one processor is further configured to:
modify the training dataset, wherein, when modifying the training dataset, the at least one processor is configured to:
generate a perturbation value of at least one data instance of the graph data associated with the graph.

14. The system of claim 8, wherein the bi-level optimization problem comprises the following formula:
$${min}_{θ} {L}_{out} ( θ + ϵ ) \\ s . t . {ϵ}^{*} ( θ ) = {arg min}_{{‖ ϵ ‖}_{2} \leq ρ} {L}_{in} ( θ + ϵ ) \\ where : \\ {L}_{out} ( θ + ϵ ) = - {L}_{in} ( θ + ϵ ) = L .$$

15. A computer program product comprising at least one non-transitory computer-readable medium including one or more instructions that, when executed by at least one processor, cause the at least one processor to:
receive a training dataset comprising graph data associated with a graph, the graph comprising a plurality of nodes and the graph data comprising node data associated with each node of the graph; and
train a graph neural network (GNN) machine learning model using a loss equation according to a bi-level optimization problem and based on the training dataset, wherein, the one or more instructions that cause the at least one processor to train the GNN machine learning model using the loss equation according to the bi-level optimization problem, cause the at least one processor to:
determine a solution to an inner loss problem, wherein, the one or more instructions that cause the at least one processor to determining the solution to the inner loss problem, cause the at least one processor to:
determine a maximum value of a difference between a first loss of the GNN machine learning model based on model parameters and a second loss of the GNN machine learning model based on the model parameters and a perturbation value;
determine a solution to an outer loss problem, wherein, the one or more instructions that cause the at least one processor to determine the solution to the outer loss problem, cause the at least one processor to:
determine model parameters that minimize the maximum value of the difference between the first loss of the GNN machine learning model based on the model parameters and the second loss of the GNN machine learning model based on the model parameters and the perturbation value.

16. The computer program product of claim 15, wherein, when training the GNN machine learning model using the loss equation according to the bi-level optimization problem, the at least one processor is configured to:
train the GNN machine learning model according to a first learning rate for the inner loss problem.

17. The computer program product of claim 15, wherein, when training the GNN machine learning model using the loss equation according to the bi-level optimization problem, the at least one processor is configured to:
train the GNN machine learning model according to a second learning rate for the outer loss problem.

18. The computer program product of claim 15, wherein, when determining the maximum value of the difference between the first loss of the GNN machine learning model based on the model parameters and the second loss of the GNN machine learning model based on the model parameters and the perturbation value, the at least one processor is configured to:
determine, using stochastic gradient descent (SGD), the maximum value of the difference between the first loss of the GNN machine learning model based on the model parameters and the second loss of the GNN machine learning model based on the model parameters and the perturbation value.

19. The computer program product of claim 15, wherein, when determining the model parameters that minimize the maximum value of the difference between the first loss of the GNN machine learning model based on the model parameters and the second loss of the GNN machine learning model based on the model parameters and the perturbation value, the at least one processor is configured to:
determine, using hypergradient descent, the model parameters that minimize the maximum value of the difference between the first loss of the GNN machine learning model based on the model parameters and the second loss of the GNN machine learning model based on the model parameters and the perturbation value.

20. The computer program product of claim 15, wherein the bi-level optimization problem comprises the following formula:
$${min}_{θ} {L}_{out} ( θ + ϵ ) \\ s . t . {ϵ}^{*} ( θ ) = {arg min}_{{‖ ϵ ‖}_{2} \leq ρ} {L}_{in} ( θ + ϵ ) \\ where : \\ {L}_{out} ( θ + ϵ ) = - {L}_{in} ( θ + ϵ ) = L .$$
